(19) United States
(12) Patent Application Publication
(10) Pub. No.: US 2021/0375001 A1
(43) Pub. Date: Dec. 2, 2021

(54) METHOD AND DEVICE FOR CALIBRATING AT LEAST ONE SENSOR

(71) Applicant: Robert Bosch GmbH, Stuttgart (DE)

(72) Inventors: Bence Erdei, Vecsés (HU); Diego Mainardi, Correggio (IT); Gaetano Riccardi, Parma (IT); Reiner Leikert, Muenchen (DE)

(21) Appl. No.: 17/319,762

(22) Filed: May 13, 2021

(30) Foreign Application Priority Data
May 27, 2020 (DE) 102020206593.4

(51) Int. Cl. G06T 7/80; H04N 5/247; G06T 7/20; G06T 7/70; H04N 17/00

(52) U.S. Cl. CPC G06T 7/80; H04N 5/247; G06T 7/20; G05D 1/0231; H04N 17/002; G06T 2207/30252; G06T 7/70

(57) ABSTRACT

A method for calibrating at least one sensor, in particular an environment sensor, of a vehicle, in which at least one calibration object is used that is located at a distance from the vehicle and is detectable by the sensor. In the method, the position of the calibration object with respect to the sensor of the vehicle is changed by moving the calibration object (2) or the vehicle. Following a change in position, the new position data are detected with the aid of the sensor, on the one hand, and with the aid of at least one external camera, on the other hand, and reconciled. A device for carrying out the method is also described.

### CROSS REFERENCE

The present application claims the benefit under 35 U.S.C. § 119 of German Patent Application No. DE 102020206593.4 filed on May 27, 2020, which is expressly incorporated herein by reference in its entirety.

### FIELD

The present invention relates to a method for calibrating at least one sensor, in particular an environment sensor, of a vehicle. The present invention relates moreover to a device for carrying out the method.

The present invention may be used in particular in vehicles driving autonomously or partly autonomously, which are usually equipped with a multitude of different sensors, in particular environment sensors such as radar, lidar, ultrasonic and/or video sensors, for example.

### BACKGROUND INFORMATION

The calibration of a vehicle sensor is usually performed manually, namely with the aid of at least one calibration object that is adapted to the respective sensor type. In order to perform the calibration, the sensor must first be positioned and/or aligned exactly with respect to the at least one calibration object. Furthermore, the deviation between the sensor axis and the axis of travel of the vehicle must be defined. In the case of a multitude of sensors, these processes have a certain complexity. For this reason, various approaches have already been developed to automate the calibration of sensors.

A method for automatically calibrating a radar sensor of a vehicle is described, for example in German Patent Application No. DE 10 2018 203 941 A1, in which the vehicle is moved with the aid of a transport means along a path past a reflector for radar waves. The reflector in this case acts as the calibration object. While the vehicle is moved along the path, the radar sensor emits radar waves in the direction of the reflector, which are reflected by the reflector and are received again by the radar sensor. The position and/or the alignment of the radar sensor relative to the reflector is/are ascertained from the received radar waves with the aid of geometric calculations at different points in time, that is, at different vehicle positions. The radar sensor is spatially calibrated on the basis of this information, a lateral shift and/or a deviation of the alignment of the radar sensor relative to a center axis of the vehicle preferably being ascertained in the process. For this purpose, it is necessary to know the distance and/or the alignment of the center axis of the vehicle with respect to the reflector. This is the case if a conveyor belt is used as a transport means, whose position with respect to the reflector is predefined. By positioning and fixing the vehicle in position on the conveyor belt, for example with the aid of rails, the position of the vehicle with respect to the reflector is thus predefined. An elaborate alignment of the vehicle or the sensor with respect to the reflector may thus be omitted.

Starting from the aforementioned related art, the present invention is based on the objective of increasing the degree of automation further in the calibration of at least one sensor of a vehicle.

To achieve the objective, the method according to an example embodiment of the present invention is provided. Advantageous developments of the present invention may be gathered from the disclosure herein. Furthermore, in accordance with an example embodiment of the present invention, a device is provided for carrying out the method.

### SUMMARY

A method is provided for calibrating at least one sensor, in particular an environment sensor, of a vehicle, in which at least one calibration object is used, which is located at a distance from the vehicle and is detectable by the sensor. According to an example embodiment of the present invention, the position of the calibration object with respect to the sensor of the vehicle is changed by moving the calibration object or the vehicle. Following a change in position, current positional data are detected with the aid of the sensor and with the aid of at least one external camera. Subsequently, the positional data detected with the aid of the sensor and of the camera are reconciled.

The fact that the positional data are detected not only with the aid of the sensor, but also with the aid of at least one external camera makes a prior exact alignment of the sensor with respect to the calibration object unnecessary. For the positional data detected by the camera may be used as comparison data so that it is possible to perform a spatial calibration of the sensor by reconciling the data detected with the aid of the sensor and the data detected with the aid of the camera.

The calibration of the sensor thus requires less time. Furthermore, it is possible to achieve a high degree of automation since an exact positioning of the sensor with respect to the calibration object is no longer required. The opposite is the case since the position of the sensor with respect to the calibration object changes continually due to the movement of the calibration object or of the vehicle. The proposed change in position is achieved by moving the calibration object with respect to the vehicle or by moving the vehicle with respect to the calibration object. The respectively other object or vehicle preferably maintains its position.

The object or vehicle that is not moved preferably occupies a position whose positional data are already known. Thus, with the aid of the at least one external camera, it is only necessary to detect the changing positional data of the moving object or vehicle. In this manner, the method may be simplified further.

According to a first preferred specific embodiment of the present invention, the calibration object is moved around the vehicle. The calibration object may be moved for example with the aid of a robotic arm or a drone. Both the robotic arm as well as the drone make it possible to move the calibration object in all three spatial directions. Furthermore, it is possible to change the alignment of the calibration object with respect to the vehicle or with respect to the sensor.

According to an alternative specific embodiment of the present invention, the vehicle is rotated. The vehicle may be rotated for example with the aid of a turntable. By rotating the vehicle, a change in position of the calibration object with respect to the sensor is achieved by a change in position of the sensor. The change in position also involves a changed alignment of the calibration object with respect to the sensor.

The position of the at least one external camera is preferably predefined in a fixed manner and the camera is furthermore not moved while the method is carried out. Ideally, the at least one external camera is situated in such a way that a triangle is spanned between the camera, the calibration object and the sensor. Based on the positional data detected with the aid of the camera at different points in time and with the aid of geometric calculations, it is possible to perform an exact position determination.

An example development of the present invention provides for the vehicle or the at least one calibration object to be moved within a previously defined calibration range, which is detected by the at least one external camera, preferably by multiple external cameras. This ensures that the moving calibration object or vehicle is always detected by the at least one camera. Preferably, multiple cameras are used for the position detection so that a greater calibration range is also completely detectable. Furthermore, the multiple cameras preferably have a respectively overlapping detection range.

It is furthermore provided for the positional data detected with the aid of the sensor and the at least one external camera to be respectively provided with a time stamp. The time stamp facilitates the reconciliation of the positional data detected at different points in time. The time stamp ensures that only positional data detected at the same time are reconciled with one another.

When implementing the method of present invention, the movement of the calibration object or of the vehicle is preferably detected continuously with the aid of the sensor and with the aid of the at least one camera. A multitude of positional data are thus detected, which may be reconciled with one another.

Preferably, 6D positional data are detected with the aid of the at least one external camera. The positional data thus also contain information with respect to the respective alignment of the calibration object with respect to the sensor.

Furthermore, all detected positional data are preferably transmitted to a processing unit for evaluation. That is to say that the reconciliation of the positional data detected with the aid of the sensor and with the aid of the at least one external camera is performed with the aid of the processing unit. For transmitting the data to the processing unit, the sensor and the at least one external camera are respectively connected to the processing unit in data-transmitting fashion. The processing unit may also already have available known positional data of a fixedly installed calibration object or of a vehicle parked in a predefined position, which respectively is not moved while the method is carried out. The known positional data may be stored in a memory of the processing unit. Advantageously, the processing unit is a component of a device for calibrating the at least one sensor.

If the position of the vehicle is not known, but rather must be determined with the aid of the at least one camera, this may be done with aid of reference marks. Reference marks already existing on the vehicle or specifically placed on the vehicle may be used for this purpose. Existing reference marks may be predefined for example by the shape of the vehicle or the vehicle type. Alternatively or additionally, an available 2D or 3D model of the vehicle may be used.

Furthermore, a device for calibrating at least one sensor, in particular an environment sensor, of a vehicle is provided. The device comprises at least one calibration object, at least one camera as well as means for moving the vehicle or the at least one calibration object. The provided device is suitable in particular for carrying out the previously described method according to the present invention, so that the same advantages may be achieved with the aid of the device.

The at least one camera of the provided device is situated in such a way that it detects both the at least one calibration object as well as the vehicle. The detection range of the at least one camera preferably defines a calibration range, within which the calibration object or the vehicle is moved. For the complete detection of a greater calibration range, a device having multiple cameras is provided, which are preferably situated in such a way that their detection ranges overlap one another.

The at least one camera is fixedly installed and is connected in data-transmitting fashion to a processing unit for evaluating the detected positional data. The processing unit is preferably likewise a component of the provided device for calibrating at least one sensor. In order to allow for the reconciliation of the positional data detected with the aid of the at least one camera and the sensor data as well as for the subsequent spatial calibration of the sensor, the sensor is preferably also connected to the processing unit in data-transmitting fashion.

The provided means for moving the vehicle or the at least one calibration object preferably comprise a robotic arm, a drone or a turntable. The calibration object may be moved around the vehicle for example with the aid of the robotic arm or the drone. The vehicle may be rotated with the aid of the turntable.

The present invention is explained in greater detail below with reference to the figures.

### BRIEF DESCRIPTION OF THE DRAWINGS

FIG. 1 shows a schematic representation of a first set-up for carrying out a method according to an example embodiment of the present invention.

FIG. 2 shows a schematic representation of a second set-up for carrying out a method according to an example embodiment of the present invention,

FIG. 3 shows a schematic representation of a third set-up for carrying out a method according to an example embodiment of the present invention and

FIG. 4 shows a schematic representation of a fourth set-up for carrying out a method according to an example embodiment of the present invention,

### DETAILED DESCRIPTION OF EXAMPLE EMBODIMENTS

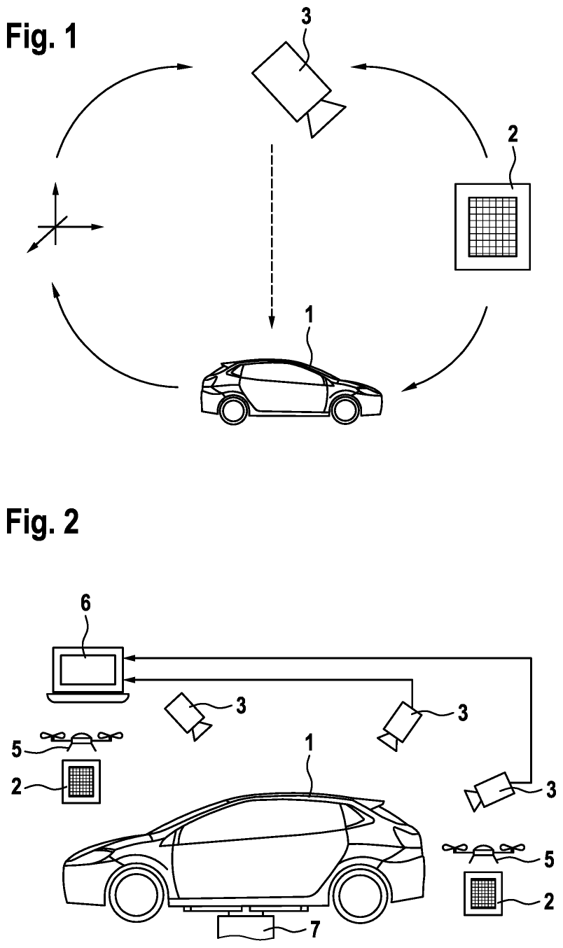

FIG. 1 shows the main components for the invention of a device of the present invention for calibrating a sensor, in particular an environment sensor, of a vehicle 1. These include at least one calibration object 2 and at least one camera 3, which are respectively situated at a distance from vehicle 1. The device further comprises means (e.g., a device) for moving the calibration object 2 or the vehicle 1 (see FIGS. 2-4). Calibration object 2, or vehicle 1, is moved by the means so that the position of calibration object 2 changes with respect to the sensor of vehicle 1. The change in position is detected both with the aid of camera 3 as well as with the aid of the sensor installed in vehicle 1. By reconciling the positional data detected with the aid of camera 3 and of the sensor, a deviation in the alignment of the sensor is detected and, if applicable, corrected.

Instead of an exact alignment of vehicle 1 or of the sensor with respect to calibration object 2, the position of calibration object 2 with respect to vehicle 1 is continuously changed, namely by moving calibration object 2 or vehicle 1. As shown in exemplary fashion in FIGS. 2 through 4, different means may be used for moving calibration object 2 or vehicle 1.

In the set-up shown in FIG. 2, vehicle 1 has a predefined position, while the position of calibration object 2 is changed with the aid of a drone 5. For this purpose, calibration object 2 is fastened to drone 5 so that drone 5 is able to fly calibration object 2 around vehicle 1. In the process, drone 5 may also assume different altitudes. The position, in particular the altitude, of vehicle 1 is defined in a fixed manner by a type of lifting platform 7. While calibration object 2 is moved with the aid of drone 5, the position of calibration object 2 changes both with respect to the sensor installed in vehicle 1 as well as with respect to camera 3 or the multiple cameras 3 shown in FIG. 2. The positional data, in particular 6D positional data, detected with the aid of the sensor and cameras 3 at different points in time are transmitted to a processing unit 6 and reconciled with the aid of processing unit 6.

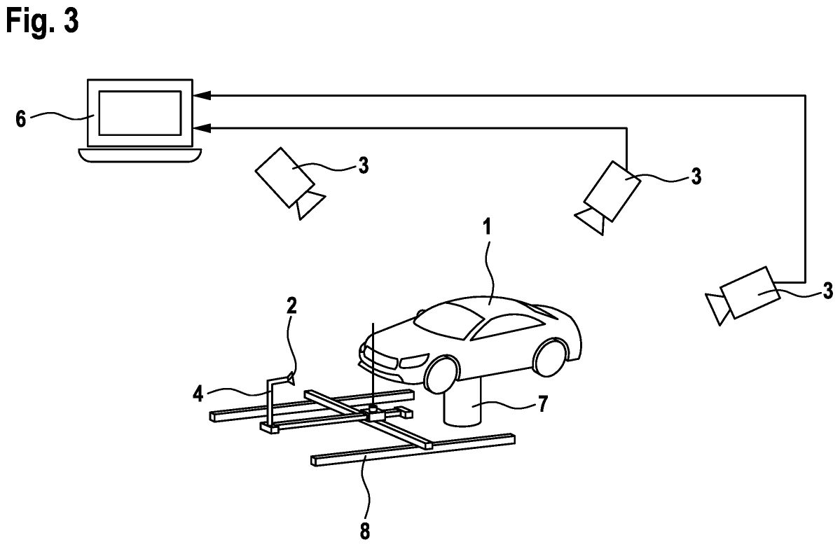

FIG. 3 shows a set-up, in which calibration object 2 is situated on a robotic arm 4 of a device for sensor calibration. Robotic arm 4 is movable in all three spatial directions on account of a system of rails 8. Moreover, robotic arm 4 may be rotated and/or tilted so that the alignment of calibration object 2 is modifiable with respect to vehicle 1. The position of vehicle 1 on the other hand is predefined in a fixed manner. For this purpose, vehicle 1 is likewise placed on a type of lifting platform 7.

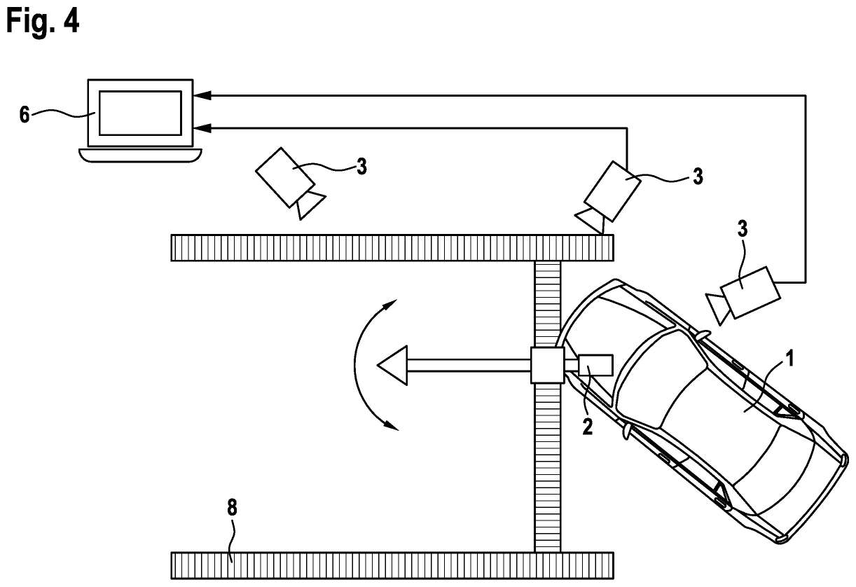

A further set-up for carrying out the method according to the present invention is illustrated in FIG. 4. Here, calibration object 2 is installed in a fixed manner on a system of rails 8, so that vehicle 1 is moved, rather than calibration object 2, vehicle 1 being in particular rotated. For this purpose, vehicle 1 is situated on a turntable (not shown), which may be designed in a similar manner as the lifting platform 7 of FIGS. 2 and 3, but which additionally also allows for vehicle 1 to be rotated.

If the turntable of the set-up of FIG. 4 is not operated, so that the position of vehicle 1 is predefined in a fixed manner, it is also possible to move calibration object 2 with the aid of the system of rails 8. Accordingly, the set-up of FIG. 4 may be used, if necessary, in an analogous manner to the set-up of FIG. 3.

What is claimed is:

1. A method for calibrating at least one sensor, in particular an environment sensor, of a vehicle, in which at least one calibration object is used that is located at a distance from the vehicle and is detectable by the sensor, the method comprising:
changing a position of the calibration object with respect to the sensor of the vehicle is changed by moving the calibration object or the vehicle; and
following the change of the position, detecting current positional data using the sensor and using at least one external camera and reconciling the current positional data detected using the sensor and the current positional data detected using the at least one external camera.

2. The method as recited in claim 1, wherein the position of the calibration object with respect to the sensor of the vehicle is changed by moving the calibration object around the vehicle.

3. The method as recited in claim 2, wherein the calibration object is moved around the vehicle using a robotic arm or a drone.

4. The method as recited in claim 1, wherein the position of the calibration object with respect to the sensor of the vehicle is changed by rotating the vehicle.

5. The method as recited in claim 4, wherein the vehicle is rotating using a turntable.

6. The method as recited in claim 1, wherein the vehicle or the at least one calibration object is moved within a previously defined calibration range, which is detected by the at least one external camera.

7. The method as recited in claim 6, wherein the at least one external camera includes multiple external cameras.

8. The method as recited in claim 1, wherein the positional data detected using the sensor and the at least one external camera are respectively provided with a time stamp.

9. The method as recited in claim 1, wherein the movement of the calibration object or of the vehicle due is detected continuously using the sensor and using the at least one external camera.

10. The method as recited in claim 1, wherein 6D positional data are detected using the at least one external camera.

11. The method as recited in claim 1, wherein all detected positional data are transmitted to a processing unit for evaluation, the processing unit being a component of a device for calibrating the at least one sensor.

12. A device for calibrating at least one sensor, comprising:
at least one calibration object;
at least one camera; and
a device configured to move the vehicle or the at least one calibration object;
wherein the device is configured to:
change a position of the calibration object with respect to the sensor of the vehicle is changed by moving the calibration object or the vehicle, and
following the change of the position, detect current positional data using the sensor and using at least one external camera and reconcile the current positional data detected using the sensor and the current positional data detected using the at least one external camera.

13. The device as recited in claim 12, wherein the at least one sensor includes an environment sensor.

14. The device as recited in claim 12, wherein the device configured to move the vehicle or the at least one calibration object includes a robotic arm, or a drone, or a turntable.
